(19) United States
(12) Patent Application Publication
(10) Pub. No.: US 2015/0189578 A1
(43) Pub. Date: Jul. 2, 2015

(54) APPARATUS, SYSTEMS AND METHODS FOR PROGRAMMABLE SIM CARD USING OVER THE AIR COMMUNICATED INFORMATION

(71) Applicant: Seek and Find AS, Snaroya (NO)

(72) Inventor: Frode van der Laak, Snaroya (NO)

(21) Appl. No.: 14/485,270

(22) Filed: Sep. 12, 2014

Related U.S. Application Data
(63) Continuation of application No. 13/304,183, filed on Nov. 23, 2011, now abandoned.
(60) Provisional application No. 61/416,945, filed on Nov. 24, 2010.

(51) Int. Cl. H04W 48/18; H04M 1/725; H04W 4/00

(52) U.S. Cl. CPC H04W 48/18; H04W 4/001; H04M 1/72563

(57) ABSTRACT

Methods, systems, and techniques for configuring mobile media devices to communicate with different networks are provided. Example embodiments provide a technique for receiving, for example, over-the-air, electronic-based SIM access information, and then reconfiguring a mobile media device for wireless communications based on the received electronic-based SIM access information.

### CROSS-REFERENCE TO RELATED APPLICATIONS

This application is a continuation of U.S. application Ser. No. 13/304,183, filed Nov. 23, 2011, entitled “APPARATUS, SYSTEMS AND METHODS FOR PROGRAMMABLE SIM CARD USING OVER THE AIR COMMUNICATED IN FORMATION,” which claims the benefit of U.S. Provisional Application No. 61/416,945, filed Nov. 24, 2010, entitled “APPARATUS, SYSTEMS AND METHODS FOR PROGRAMMABLE SIM CARD USING OVER THE AIR COMMUNICATED INFORMATION,” both of which are incorporated herein by reference in their entireties.

### TECHNICAL FIELD

The present disclosure relates to methods, techniques, and systems for configuration of mobile devices and, in particular, to methods, techniques, and systems for configuration of mobile devices using programmable SIM cards.

### BACKGROUND

Wireless media devices, such as a cellular telephone, a smartphone, a personal device assistant (PDA), a portable computer, a netbook, a cellular-enabled global positioning system (GPS) device, or the like, are often configured to communicate voice messages and other content over a cellular-based communication network (cellular network). Typically, cellular networks are privately owned by service providers that operate the cellular network for profit. Access to and use of the cellular network is provided to customers of the service provider that are subscribing for service to that particular cellular network. Access to and use of a particular cellular network is tightly controlled by the service provider so that non-authorized devices cannot be used to access or use the cellular network. Further, the service provider may limit, or lock, the authorized media device so that it may only access and use the cellular network of the service provider, thereby preventing access to other cellular networks operated by competing service providers.

Access to and use of the cellular network is controlled by a subscriber identity module (SIM) card or other security device that is installed in the wireless media device. The SIM card includes a unique identifier that is associated with the service provider and the subscribing customer. Exemplary SIM card identifiers include a unique serial number, an internationally mobile subscriber identity (IMSI), a security authentication, ciphering information, and other temporary information related to the cellular network that the customer has subscribed to. In some instances, the SIM card includes a list of the services the user has access to, and/or or may include one or more passwords (such as, but not limited to, a PIN for usual use and PUK for unlocking).

The SIM card, when inserted into the wireless media device, acts to control communications between the wireless media device and the cellular network. Communications to and from the wireless media device are permitted when the communications have included therein information that is associated with the unique identifier of the SIM card. That is, if the unique identifier of the SIM card indicates that a particular wireless media device is authorized to access and use that cellular network, then the cell site of the authorized cellular network that is within the broadcast range of the wireless media device establishes a communication link between the wireless media device and another electronic device. If the unique identifier of the SIM card indicates that a communicating wireless media device is not authorized to access and use a non-authorized cellular network, then the cell site of the non-authorized cellular network that is within the broadcast range of the wireless media device ignores or otherwise disregards communications from the broadcasting wireless media device.

The SIM card allows users to change wireless media devices by simply removing the SIM card from one wireless media device and inserting it into another wireless media device. However, the user of the wireless media device is still limited to using the particular authorized cellular network of the service provider that has enabled the SIM card for access to and use of its particular cellular network. The user cannot use the wireless media device to access or use other non-authorized cellular networks without special provisioning, which typically is provided as a premium service that the customer must pay for.

### BRIEF DESCRIPTION OF THE DRAWINGS

Example embodiments are described in detail below with reference to the following drawings:

FIG. 1 is an example block diagram of an embodiment of an electronic subscriber identity module (SIM) system;

FIG. 2 is an example block diagram of an exemplary wireless media device with an exemplary embodiment of the electronic SIM card;

FIG. 3 is an example block diagram of an exemplary alternative wireless media device provisioned with an exemplary embodiment of the electronic SIM card;

FIG. 4 is an example block diagram of selected components at an exemplary customer service portal; and

FIG. 5 is an example block diagram of an exemplary server farm environment that permits various entities access to the user's wireless media device via the customer service portal.

### DETAILED DESCRIPTION

Systems, methods, and techniques of receiving electronic-based SIM access information, and then reconfiguring a mobile device for wireless communications based on the received electronic-based SIM access information, are disclosed. An exemplary embodiment electronically receives the electronic-based SIM access information in an over the air (OTA) wireless signal.

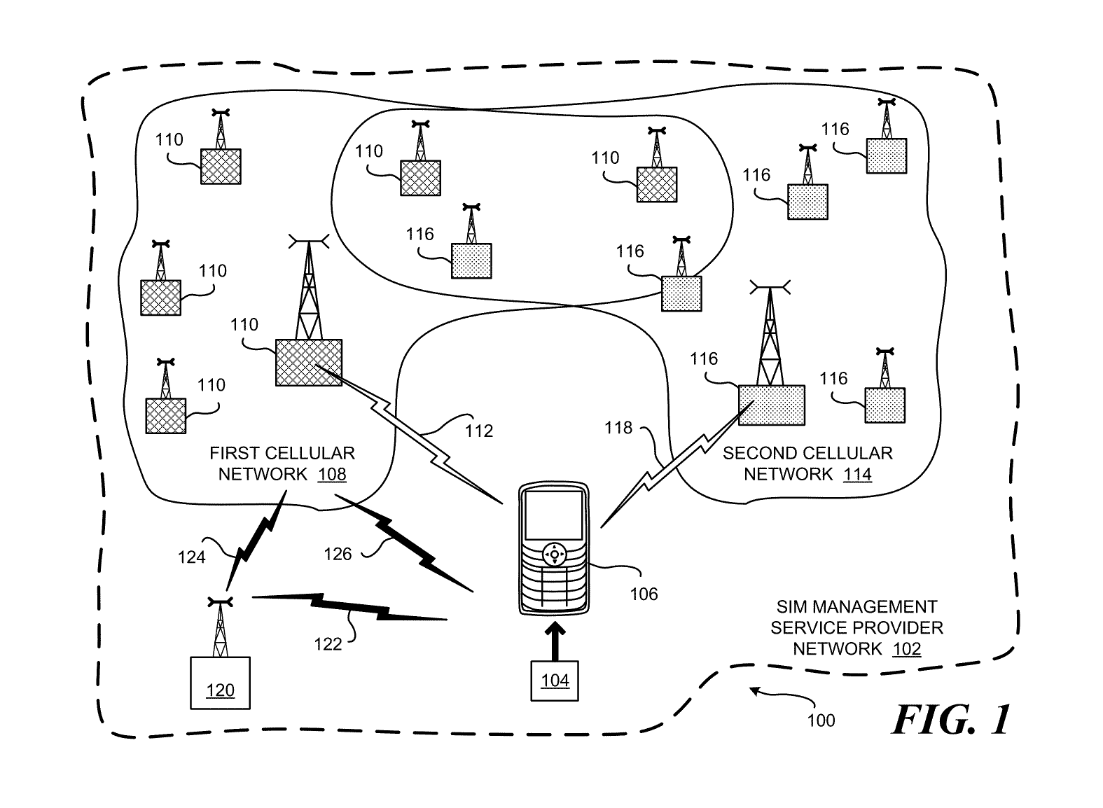

FIG. 1 is a block diagram of an embodiment of an electronic subscriber identity module (SIM) system 100. Embodiments of the electronic SIM system 100 comprises a SIM management service provider network 102 that provides electronic-based SIM access information to a subscribing electronic SIM card 104 residing in a wireless media device 106. Non-limiting examples of the wireless media device 106 include a cellular telephone, a smartphone, a personal device assistant (PDA), a personal computer (PC), a portable computer, a laptop PC, a netbook, a cellular-enabled global positioning system (GPS) device, a wireless PC card, and the like.

The user of the wireless media device 106 provisioned with the electronic SIM card 104 is able to selectively access and use one or more different cellular networks that are operated by different service providers based upon the electronic SIM access information provided by the SIM management service provider network 102. In contrast with legacy SIM cards where the unique identifiers in the SIM card are fixed to enable service to a particular authorized service provider, embodiments of the electronic SIM card 104 are configured to receive the electronic SIM access information so that the wireless media device 106 may be selectively (and/or dynamically) configured to operate on one or more specified cellular networks. Accordingly, the user of the wireless media device 106, in an exemplary embodiment, may contact the electronic SIM (E-SIM) management service provider and request SIM card identifiers to enable access to and use of a particular cellular network of interest. The electronic SIM access information may even be communicated wirelessly over the SIM management service provider network 102 to the wireless media device 106. Based on the received electronic SIM access information, the electronic SIM card 104 is configured to enable the wireless media device 106 to access any particular cellular network of interest.

For example, the wireless media device 106 provisioned with the electronic SIM card 104 may be selectively configured to access and use the first cellular network 108 by configuring the electronic SIM card 104 with access information associated with the first cellular network 108. Once the electronic SIM card 104 has received the electronic SIM access information, the wireless media device 106 is enabled to communicate over the first cellular network 108. Thus, a wireless communication link 112 may be established between the base station 110 of the first cellular network 108 and the wireless media device 106.

At other times, the user may selectively access and use the second cellular network 114 by reconfiguring the electronic SIM card 104 to enable their wireless media device 106 to communicate with the base station 116 of the second cellular network 114. For example, when the user is in a different city, the user may prefer to use the second cellular network 114 because of cost and/or service quality considerations.

To access and use the second cellular network 114, the electronic SIM access information associated with the second cellular network 114 is provided to the electronic SIM card 104 by the SIM management service provider network 102. Thus, after the electronic SIM access information authorizing access to the second cellular network 114 is received and loaded into the electronic SIM card 104, a second wireless communication link 118 may be established between the base station 116 of the second cellular network 114 and the wireless media device 106.

The communication of the electronic SIM access to the wireless media device 106 can be communicated via an OTA signal. In some embodiments, the electronic SIM access information may be communicated to the electronic SIM card 104 over an internet protocol (IP) link. For example, if the user has their home PC on line, and/or has traveled to another location (such as another city and/or country), the electronic SIM access information can be provided over the established IP network or over another network.

As yet another example, the user may have a plurality of SIM profiles each having electronic SIM access information that authorizes access to and use of a particular cellular network. Selected electronic SIM access information can be communicated to the electronic SIM card 104, via an OTA link, an IP link, or any other suitable communication link. Accordingly, the wireless media device 106 can be selectively authorized to access and use a selected cellular network associated with the received electronic SIM access information. For example, if the user is travelling to another city and/or country, the user can request the electronic SIM access information for a selected service provider operating a cellular network in the city and/or country. The associated electronic SIM access information can be downloaded to the user's wireless media device 106 over an IP link established before, or even during, the user's trip to the other city and/or country. In various exemplary applications, the wireless media device 106 may then be reconfigured to support voice calls, conference calls, media content exchanges, and/or data communications over the cellular network in the other city and/or country.

In some situations, because of different cost and/or service quality considerations, and where service coverage of the first cellular network 108 and the second cellular network 114 overlap, the user may prefer to use the first cellular network 108 for a first type of communication, and may prefer to concurrently use the second cellular network 114 for a second type of communication. For example, but not limited to, the service provider of the first cellular network 108 may provide voice services at a lower cost and the service provider of the second cellular network 114 may provide data services at a higher quality. Accordingly, the user may selectively configure the electronic SIM card 104 to enable their wireless media device 106 to communicate with the base station 110 of the first cellular network 108 for telephone calls, and may concurrently configure the electronic SIM card 104 to enable their wireless media device 106 to communicate with the base station 116 of the second cellular network 114 for Internet service, e-mail, or other data intensive communications.

In an exemplary embodiment, the SIM management service provider network 102 comprises at least one customer service portal 120 that stores, or has access to, the electronic SIM access information pertaining to subscribing customers. The customer service portal 120 may also have the electronic SIM access information pertaining to one or more different cellular systems that the customer subscribes to and/or is authorized to access and use. In an exemplary embodiment, in response to a request from the user of the wireless media device 106 provisioned with the electronic SIM card 104, the E-SIM management service provider accesses the customer's information associated with the wireless media device 106, and then accesses the electronic SIM access information associated with the particular cellular network of interest. The information is used to generate the electronic SIM access information that is used to configure the electronic SIM card 104 to enable the wireless media device 106 to access and use the selected cellular network of interest.

In some embodiments, the electronic SIM access information associated with the particular cellular network of interest is communicated directly to the wireless media device 106 via an over the air (OTA) communication link 122 that is received by the wireless media device 106. For example, the E-SIM management service provider may operate a cellular base station or the like that is configured to transmit wireless communications to, and receive wireless communications from, the wireless media device 106. In response to receiving a request to access a particular cellular network of interest, the electronic SIM access information is then transmitted, via the OTA communication link 122, to the wireless media device 106.

Alternatively, or additionally, the customer service portal 120 may communicate the electronic SIM access information associated with the particular cellular network of interest to a cellular network, via an OTA communication link 124, that the wireless media device 106 is currently authorized to access and use. For example, the electronic SIM access information may be communicated over the OTA communication link 124 (or other wire-based link) that is received by the first cellular network 108. Since the wireless media device 106 is authorized to communicate over the first cellular network 108, the wireless media device 106 receives the electronic SIM access information via a second OTA communication link 126.

The electronic SIM access information may be communicated to the wireless media device 106 using any suitable communication medium that the wireless media device 106 is authorized to use. The electronic SIM access information may be communicated wirelessly, using a radio frequency signal (RF), a cellular signal, or the like.

Alternatively, or additionally, the electronic SIM access information may be communicated over a wire-based communication network, such as a cable system or the Internet.

Further, the electronic SIM access information may be communicated over hybrid communication systems. For example, but not limited to, the wireless media device 106 may be communicatively coupled to the Internet via a WiFi system that is in proximity to the wireless media device 106. The base station 116 may include a web server or the like, which is accessed by the customer using their wireless media device 106. The base station 116 may then communicate the electronic SIM access information over the Internet to the wireless media device 106.

As another example, the wireless media device 106 may be communicatively coupled to a legacy public telephony system. The wireless media device 106 may contact the E-SIM management service provider, wholly or partially, over the legacy public telephony system. Once the electronic SIM access information is delivered to the wireless media device 106 over the legacy public telephony system, the electronic SIM card 104 may be reconfigured to access and use the particular cellular network of interest associated with the acquired electronic SIM access information.

As yet another example, the wireless media device 106 may be communicatively coupled to a wire-based (a wired) system, such as a fiber optics system, a local access network (LAN) system, an Ethernet system, a cable system, an infrared system, a satellite system, or a hybrid system comprised of multiple types of communication media. Additionally, embodiments of the wireless media device 106 may be configured to communicate using other types of communication technologies, such as but not limited to, digital subscriber loop (DSL), X.25, Internet Protocol (IP), Ethernet, Integrated Services Digital Network (ISDN) and asynchronous transfer mode (ATM). Also, embodiments of the wireless media device 106 may be configured to communicate on combination systems having a plurality of segments which employ different formats for each segment employing different technologies on each segment. The wireless media device 106 may contact the E-SIM management service provider, wholly or partially, over these various communication systems to acquire the electronic SIM access information associated with the particular cellular network of interest.

Any suitable information may be incorporated into the electronic SIM access information that is communicated to the wireless media device 106 provisioned with the electronic SIM card 104. Cellular network access information included in the electronic SIM access information may include, but is not limited to, network-specific information used to authenticate and identify subscribers on the network, such as, but not limited to, an electronic serial number, a Home Network Identity (HNI), a mobile country code (MCC), a mobile network code (MNC), an integrated circuit card identifier (ICC-ID), an international subscriber mobility identifier (IMSI), an Authentication Key (Ki), a Local Area Identity (LAI), and/or an Operator-Specific Emergency Number. The electronic SIM access information may also include other carrier specific data such as the SMSC (Short Message Service Center) number, Service Provider Name (SPN), Service Dialing Numbers (SDN), Advice-Of-Charge parameters and Value Added Service (VAS) applications, roaming authorization information, and other suitable service entitlement information. Additionally, the electronic SIM access information may optionally include customer information pertaining to the subscriber, such as name, age, address, billing information, other authorized users, personal passwords, or the like.

Further, embodiments of the electronic SIM card 104 may be configured to enable communications over one or more communication network types. For example, a exemplary electronic SIM card 104 may be configured to enable the wireless media device 106 to communicate under one or more of the following standardized communication technologies: global system for mobile communications (GSM), universal mobile telecommunications system (UMTS), code division multiple access (CDMA), evolution-data optimized (EVDO), IMT multi-carrier (IMT-MC), 3g, and/or or 4g. As new communication technologies evolve and are implemented, embodiments of the electronic SIM card 104 may be reconfigured to enable the wireless media device 106 to access and communicate over such new technologies. Other wireless technologies may also be included, such a wireless local area network (WLAN) system based on the IEEE 802.11 standards. Alternatively, or additionally, embodiments may be configured to enable connectivity to a communication system or network (such as Wi-Fi, Super Wi-Fi, Wi-Fi Peer to Peer, and/or Wi-Fi Direct), and/or to other technologies that support PAN, LAN, and even Wide Area Network (WAN) connections.

The electronic SIM card 104 may be configured in any suitable enclosure so as to be received into the wireless media device 106. Non-limiting examples of the enclosure format include full-sized SIM card slots, mini-sized SIM card slots, micro-sized SIM card slots, and Personal Computer Memory Card International Association (PCMCIA) card slots. Thus, embodiments of the electronic SIM card 104 may be configured to fit into or couple with any type of wireless media device 106. In some embodiments, the electronic SIM card 104 may be a component that is secured into the wireless media device 106 at some point during its fabrication, and is therefore, not a removable component.

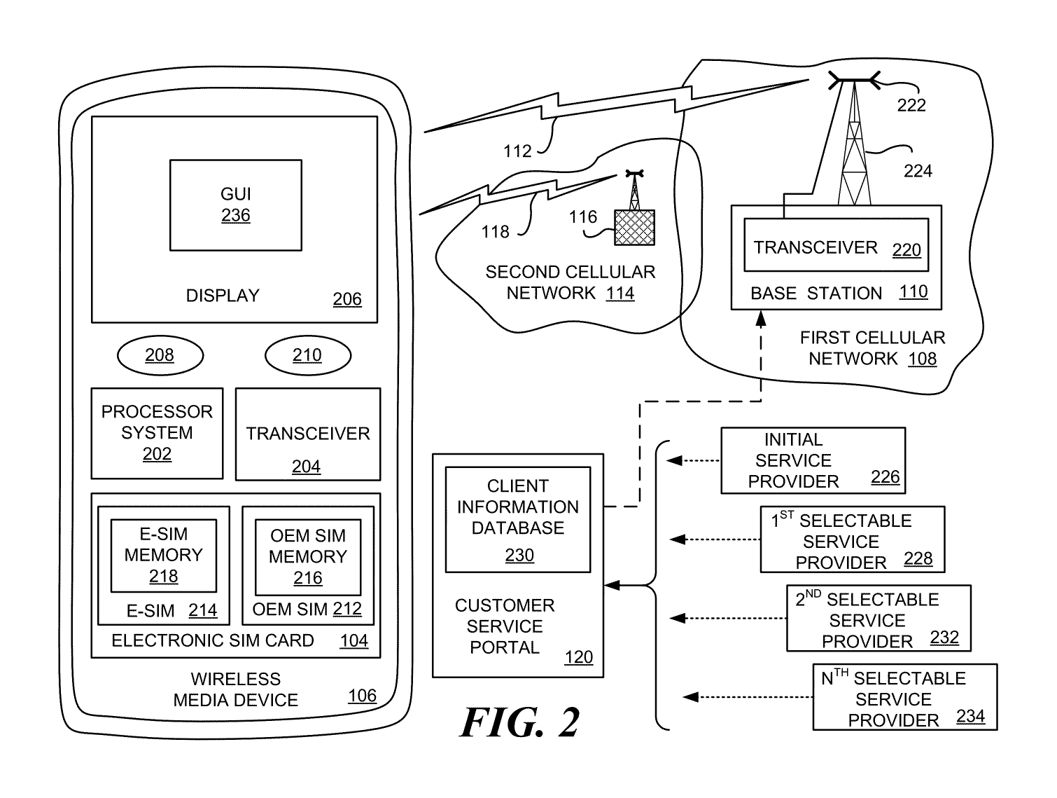

FIG. 2 is a block diagram of an exemplary wireless media device 106 provisioned with an exemplary embodiment of the electronic SIM card 104. The exemplary wireless media device 106 comprises a processor system 202, a transceiver 204, a display 206, a speaker 208, a microphone 210, and the exemplary embodiment of the electronic SIM card 104. In this exemplary embodiment, the OEM SIM 212 and the E-SIM 214 may be implemented as a single SIM card module. The OEM SIM 212 and/or the E-SIM 214 may be implemented as software, firmware, or a combination thereof.

The exemplary electronic SIM card 104 comprises an original equipment manufacturer (OEM) SIM 212 portion and an electronic SIM (E-SIM) 214 portion. The OEM SIM 212 comprises an OEM SIM memory 216. The E-SIM 214 comprises an E-SIM memory 218. In an exemplary embodiment, the OEM SIM 212 and the E-SIM 214 are an integrated module configured to fit into a corresponding receptacle or slot in the wireless media device 106. The OEM SIM 212 and the E-SIM 214 may share common components (not shown) depending upon the embodiment.

The processor system 202 of the wireless media device 106 is configured to manage communications between the wireless media device 106, the base station 110, and a remote device (not shown), such as another mobile device, an internet site, a server system, or the like. The wireless media device 106 is configured to establish one or more communication links to selected cellular networks based upon the electronic SIM access information stored in the OEM SIM memory 216 and/or the E-SIM memory 218.

When the user of the wireless media device 106 wishes to access and use the first cellular network 108, a signaling request is transmitted from the transceiver 204 of the wireless media device 106. When the wireless media device 106 is within reception range of the base station 110, the signaling request is detected at the antenna 222. The transceiver 220 is coupled to an antenna 222 that may be optionally located on a tower 224 or other structure.

The signaling request, which includes the electronic SIM access information, is used to establish access rights of the wireless media device 106 to use the first cellular network 108. Once such access rights are verified, the wireless communication link 112 is established between the transceiver 204 and a transceiver 220 in the base station 110. The wireless communication link 112 supports various types of communications that the user of the wireless media device 106 wishes to establish with other remote devices to perform various functions, such as voice communications, data communications, or the like.

Audio information received by the wireless media device 106 may be emitted from the speaker 208 so as to be heard by the user of the wireless media device 106. Image information, such as still images and/or video clips, may be presented on the display 206 for viewing by the user. Detected sounds, such as the user's voice, may be detected by the microphone 210 and incorporated into a wireless communication signal transmitted from the wireless media device 106.

For example, the wireless media device 106 may be a cellular phone. In this simplified example, the speaker 208 and microphone 210 support voice communications between the user of the wireless media device 106 and a user of a remote cell phone. Pictures received at the cell phone may be presented on the display 206.

As another example, the wireless media device 106 may be a portable computer, laptop, netbook, or the like that is communicatively coupled to a WiFi base station (here the illustrated base station 110) or a cellular network. Accordingly, the user of the mobile device 106 may access an internet site, e-mail system, or the like, over the established wireless communication link 112. A browser operating in the wireless media device 106 may access various web page images, which are presented to the user on the display 206. If audio information, such as music or a voice recording, is available from the accessed web page, the received audio information may be emitted from the speaker 208 and heard by the user.

Since there are many different types of wireless media devices 106 that may be provisioned with embodiments of the electronic SIM card 104, the simplified electronic wireless media device 106 presented in FIG. 1 may include additional components that are not shown, or may include fewer components in other embodiments. Any such variations in a wireless media device 106 provisioned with an embodiment of the electronic SIM card 104 are intended to be within the scope of this disclosure.

The exemplary embodiment of the electronic SIM card 104 may be initially provisioned with information configured to provide initial access to a predefined cellular network, such as the exemplary first cellular network 108 operated by the initial service provider 226. For example, the wireless media device 106 may be a cellular phone manufactured and distributed to the user by an authorized OEM vendor. The wireless media device 106, when initially received by the user, may be initially configured to access the first cellular network 108 operated by the initial service provider 226 using initial SIM access information that has been pre-stored on the OEM SIM memory 216. The initial SIM access information may be identical to, or very similar to, the SIM access information used on a legacy SIM card. Optionally, the initial SIM access information may include desirable security features to prevent tampering and/or modification of the initial SIM information after delivery of the wireless media device 106 to the user.

In this situation, the E-SIM memory 218 would likely not include any electronic SIM access information that would enable the wireless media device 106 to access other cellular networks and/or wireless systems that are not owned and/or operated by the initial service provider 226. Once the user comes into possession of the wireless media device 106, and after authorization is received to use the first cellular network 108 operated by the initial service provider 226, the user may operate their wireless media device 106 to establish the wireless communication link 112 with the nearby base station 110. The user may then operate the wireless media device 106 for its intended purpose by wirelessly communicating over the established wireless communication link 112. For example, if the wireless media device 106 is a cellular phone, the user may conduct voice conversations with other individuals over the first cellular network 108 operated by the initial service provider 226.

At some point after initial activation of the wireless media device 106, the user may wish to obtain electronic SIM access information that will enable the wireless media device 106 to access and use other cellular networks and/or wireless systems, such as the exemplary second cellular network 114 operated by the first selectable service provider 228. In this situation, electronic SIM access information must be first obtained for other cellular networks and/or wireless systems.

To obtain the electronic SIM access information for the other cellular networks and/or wireless systems, in an exemplary embodiment, the user first establishes communications with the customer service portal 120 operated by the E-SIM management service provider. For example, but not limited to, the user might place a call into the customer service portal 120 using the wireless communication link 112 established with the base station 110 operated by the initial service provider 226. Alternatively, or additionally, if the wireless media device 106 has Internet access, the user may log into or otherwise contact an Internet site operated by the E-SIM management service provider.

The user would then provide their user identity information, account information, and/or security information to the E-SIM management service provider. Once the E-SIM management service provider is satisfied of the identity and/or authorization of the user, the electronic SIM access information associated with the user for one or more of the other cellular networks and/or wireless systems may be retrieved from the client information database 230. The retrieved electronic SIM access information may then be communicated to the wireless media device 106 over the wireless link 112 established with the base station 110 operated by the initial service provider 226. Alternatively, the electronic SIM access information may be communicated to the wireless media device 106 over other available paths, such as if the wireless media device 106 is also coupled to the Internet via a wire-type connector, a WiFi connection, or the like.

The received electronic SIM access information is stored into the E-SIM memory 218. At some point, the user may wish to establish the exemplary second communication link 118 to the second cellular network 114 operated by a first selectable service provider 228. The user would then operate their wireless media device 106 to access the stored electronic SIM access information. The stored electronic SIM access information reconfigures the wireless media device 106 so that signaling communications emitted by the transceiver 204 of the wireless media device 106 is received by the base station 116 that is operated by the first selectable service provider 228. Since the signaling communication emitted by the wireless media device 106 is recognized as valid with respect to accessing and using the second cellular network 114, the base station 116 establishes the second communication link 118 with the wireless media device 106. Then, the user may use the wireless media device 106 for its intended purpose using the established wireless link 112. For example, if the wireless media device 106 is a cellular phone, the user may conduct voice conversations with other individuals over the exemplary second cellular network 114 operated by the first selectable service provider 228.

Embodiments of the electronic SIM card 104 may be configured to receive and store electronic SIM access information associated with a plurality of different service providers. For example, the user may be a subscriber to, or may receive authorization, to use a third cellular network (not shown) operated by a second selectable service provider 232. SIM information required to permit the wireless media device 106 to access and use the cellular network (not shown) operated by second selectable service provider 232 may be provided to the E-SIM management service provider. The SIM information associated with a third cellular network may then be stored into the client information database 230 and associated with the user.

In some applications, electronic SIM access information that is not associated with any particular user may be received from many different service providers and stored into the client information database 230. For example, the exemplary N^{th} selectable service provider 234 may provide the electronic SIM access information to the E-SIM management service provider. At some point, the user may wish to access and use the cellular network (not shown) operated by the N^{th} selectable service provider 234. The user would contact the N^{th} selectable service provider 234 and become a subscriber to their service. In one exemplary application, the N^{th} selectable service provider 234 would then provide its cellular network information, the electronic SIM access information, the identity information of the newly subscribed user, and/or the identity information of the wireless media device 106, to the E-SIM management service provider. This information would then be stored into the client information database 230 and associated with the N^{th} selectable service provider 234. Then, when the user operates their wireless media device 106 to request the electronic SIM access information for accessing and using the cellular network operated by the N^{th} selectable service provider 234, after access privileges have been confirmed by the E-SIM management service provider, the electronic SIM access information may be communicated to the wireless media device 106.

In another application, the electronic SIM access information for accessing and using the cellular network operated by the N^{th} service provider 234 may be automatically communicated to (i.e.; pushed to) the wireless media device 106 and stored in the E-SIM memory 218. For example, after receiving the electronic SIM access information and authorization for the user, the customer service portal 120 may initiate a communication with the wireless media device 106. When the wireless communication link 112 (or another communication link) is established with the wireless media device 106, the electronic SIM access information for accessing and using the cellular network operated by the N^{th} selectable service provider 234 may be communicated to the wireless media device 106. Accordingly, the user may initiate access with and begin using the cellular network of the N^{th} selectable service provider 234 at any time of their choosing.

In another application, the electronic SIM access information for accessing and using the cellular network operated by the N^{th} service provider 234 may be directly communicated to the wireless media device 106 and stored in the E-SIM memory 218. For example, after the user subscribes to the services provided by the N^{th} service provider 234, the electronic SIM access information may be communicated to the wireless media device 106 over the already-established wireless communication link 112.

In other embodiments, various components of the electronic SIM card 104 may share components. For example, but not limited to, the OEM SIM memory 216 and the E-SIM memory 218 may be implemented as a single memory device and/or integrated together in a common database. Connectors that communicatively couple the electronic SIM card 104 into the receptacle or slot of the wireless media device 106 may be commonly shared. Further, some embodiments may include connectors that match with and correspond to the connectors used by a legacy SIM card. Accordingly, the electronic SIM card 104 may be used in a legacy wireless media device 106 that was initially intended to be operated using the legacy SIM card.

The electronic SIM card 104 may comprise other components not shown. For example, one or more processor systems may be included in the electronic SIM card 104 to manage various functions, such as storing and/or retrieving electronic SIM access information, user information, account information or the like into the OEM SIM memory 216 and/or the E-SIM memory 218. A processor system implemented in the electronic SIM card 104 may be configured to provide access to selected electronic SIM access information that will be used to manage the configuration of the wireless media device 106.

In this exemplary embodiment, the processor system 202 would be operated by the user to select the electronic SIM access information based upon the particular cellular network that the user wishes to access and use. In an exemplary embodiment, a graphical user interface (GUI) 236 is presented on the display 206 that indicates to the user available choices of service providers and/or of cellular networks that the user is currently authorized to access and use. Alternatively, or additionally, the GUI 236 may indicate other cellular networks and/or wireless systems that the user may wish to subscribe to. That is, the GUI 236 indicates to the user which particular service providers and/or cellular networks have their electronic SIM access information downloaded into the E-SIM memory 218, and/or which other cellular networks and/or wireless systems the electronic SIM access information may be available if the user subscribed to their service.

The user may, in some embodiments, operate the controllers (i.e.: buttons) on the surface of their wireless media device 106 to navigate about the GUI 236 and select one of the service providers and/or cellular networks of interest. In an embodiment with a touch-sensitive display 206, the user may scroll about the GUI 236 and select a service provider and/or cellular network of interest by touching the surface of the display 206. Upon selection, the wireless media device 106 configures itself using the electronic SIM access information so that the wireless media device 106 is reconfigured to access the selected cellular network.

The GUI 236 may optionally indicate other information and/or make recommendations to the user. For example, the user may be traveling to an unfamiliar city and/or country, where service costs and/or service quality may be different than what the user is accustomed to while at their home location. Recommendations may be made for subscribing to other local cellular networks and/or local wireless systems. Advertisements or the like may be presented to the user on the GUI 236 based upon location information derived or obtained for the wireless media device 106.

In another exemplary application, the user of the wireless media device 106 may contact the E-SIM management service provider over the initially established wireless communication link 112. The initial electronic SIM access information that authorizes access and use of the first cellular network 108 may be communicated from the wireless media device 106 to the E-SIM management service provider. Or, the electronic SIM access information may be obtained by the E-SIM management service provider from another source, such as, but not limited to, the initial service provider 226. The E-SIM management service provider may then provision the electronic SIM card 104 with the initial electronic SIM access information, and then provide the electronic SIM card 104 to the user. The user may then switch out the legacy SIM card in their wireless media device 106 with the received electronic SIM card 104.

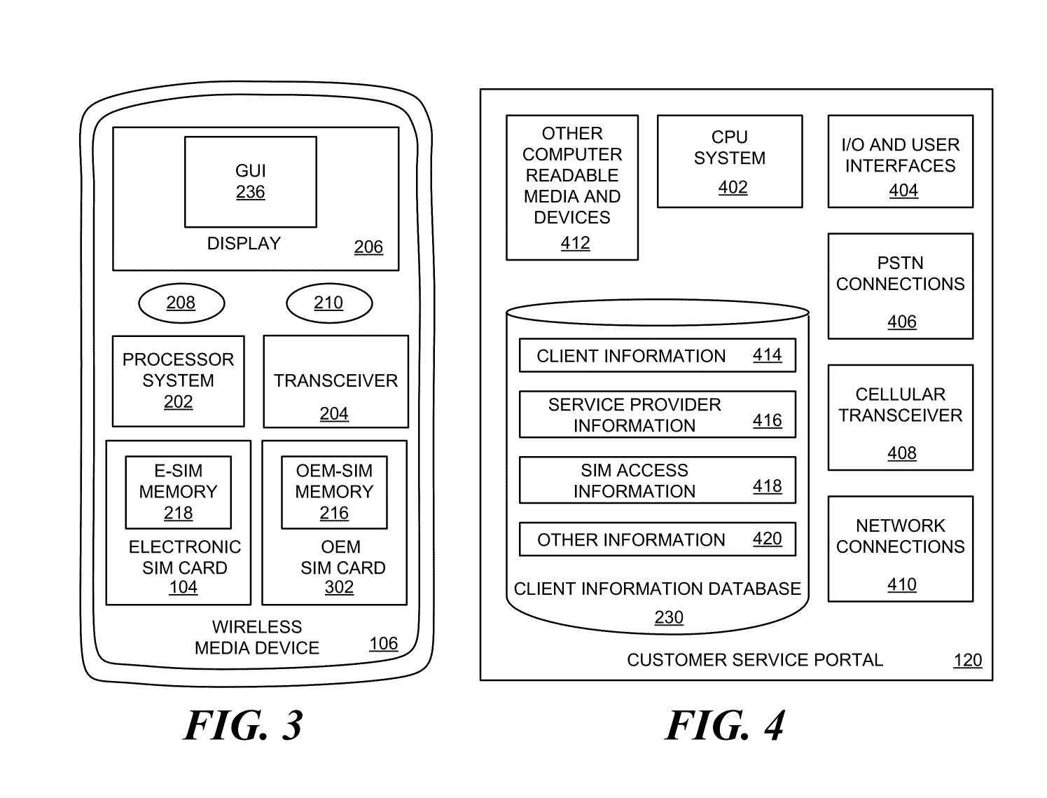

FIG. 3 is a block diagram of an exemplary wireless media device 106 provisioned with an alternative exemplary embodiment of the electronic SIM card 104. In this embodiment, the wireless media device 106 is configured to separately receive two SIM cards, an OEM SIM card 302 and the electronic SIM card 104.

In an exemplary embodiment, the OEM SIM card 302 may be a legacy SIM card that is received in a first receptacle or slot in the wireless media device 106. The wireless media device 106 may be configured with a second receptacle, slot, or the like, that is configured to separately receive the electronic SIM card 104. For example, the electronic SIM card 104 may be configured to couple to the wireless media device 106 using an extra SIM card slot, a PCMCIA slot, a uniform serial bus (USB) port, or other communication port that is available on the wireless media device 106.

FIG. 4 is a block diagram of selected components of an exemplary customer service portal 120. The exemplary embodiment of the customer service portal 120 comprises the client information database 230 (and/or other data repository), a central processing unit (CPU) system 402, one or more input/output interfaces 404, an optional public system telephony network (PSTN) connection 406, one or more optional cellular transceivers 408, and/or one or more optional network connections 410. Other embodiments of the customer service portal 120 may include other components and/or devices (not shown), and/or may include fewer devices and/or components, depending upon the particular functionality provided the customer service portal 120. Further, some embodiments of the customer service portal 120 may be geographically dispersed and/or employ a distributed architecture. In an exemplary embodiment, a plurality of customer service portals 120 may be deployed based on client demand and/or client characteristics. For example, customer service portals 120 may be located in the United States, in Europe, or even in particular countries, cities and/or other regions of interest based on one or more selected customer demographics, such as language. As another example, a customer service portal 120 may be located so as to have access to one or more cellular networks that are located in a common geographic region.

The client information database 230 comprises portions for storing the client information 414, service provider information 416, SIM access information 418, and/or other information of interest 420. Further, embodiments of the customer service portal 120 may have the client information database 230 geographically dispersed and/or employ a distributed architecture. For example, the client information database 230 may reside in different memory media. The different memory media storing the client information database 230 may be geographically dispersed, for example, as in different locations in the United States, in Europe, or even in particular countries, cities and/or other regions of interest.

Embodiments may employ any suitable CPU system 402 that may be configured to manage and distribute the electronic SIM access information to users that are subscribers to the E-SIM management service provider, to receive electronic SIM access information from one or more service providers, to receive and respond to requests from subscribing users, and/or to receive other information of interest. Embodiments may employ a large centralized computing system, a server-based system with many computing systems, and/or a decentralized network of computing systems. For example, but not limited to, the customer service portal 120 may be configured similar to a customer call or service center having a plurality of networked personal computers that are configured to access a relatively larger computing system that manages the client information database 230. Another embodiment may be configured as a peer to peer network.

I/O interfaces 404 may be provided to allow personnel of the E-SIM management service provider to perform various service related and/or management functions to the client information database 230 and/or other components residing in the customer service portal 120. For example, but not limited to, a service technician may periodically access the client information database 230 to perform backup operations of the information residing in the client information database 230.

The PSTN connection 406 may communicatively couple the customer service portal 120 to a local telephony system. In such embodiments, the user of the wireless media device 106 may place a telephone call into the customer service portal 120 to receive assistance and/or services from a call center operator or the like. For example, the user may want to make arrangements to become a subscriber, discuss service provider alternatives, or discuss other issues with a person that is able to provide personalized service to the user.

The cellular transceiver 408 may be configured to access a local cellular network. For example, the cellular transceiver 408 may be configured to access and communicate to the base station 110 of the first cellular network 108 and/or the base station 116 of the second cellular network 114. Here, the user may establish a suitable cellular based connection directly from their wireless media device 106 to the customer service portal 120. Alternatively, or additionally, the user may use another communication medium to communicate to the customer service portal 120. Here, the cellular transceiver 408 provides the connectivity to and from the customer service portal 120.

The network connection 410 may be configured to enable access to the Internet or to another networked system. For example, the user may establish a suitable Internet-based connection directly from their wireless media device 106 using a suitable web browser or the like. The user may alternatively access the network connection 410 from another device, such as their personal computer located at their residence or at their workplace.

The other computer readable media and devices 412 may provide connectivity between the customer service portal 120 and other entities. Various information of interest may be exchanged between the E-SIM management service provider and other entities. For example, a device 412 may be a server or the like that is configured to receive information that pertains to a subscriber, such as account information, access information, historical usage information, and even advertisement media.

In the exemplary embodiment, the customer service portal 120 is able to store various information pertaining to the subscribers in the client information 414 portion of the client information database 230. Information may include addresses, names, billing information, special identifiers, or the like, of the user or other related persons.

The information may optionally include information that is associated with one or more of the user's wireless media devices 106. For example, the user may have a cellular phone and a portable laptop computer. Serial numbers, make/model information, and other identifiers of the multiple wireless media devices 106 may be stored in the client information 414 portion of the client information database 230 such that the electronic SIM access information may be configured as necessary for each of the multiple wireless media devices 106.

In an exemplary embodiment, information pertaining to a service provider may be stored in the service provider information 416 portion of the client information database 230. For example, information regarding the particular characteristics of the cellular network and/or wireless system operated by the service provider may be stored. Alternatively, or additionally, access information that is used to construct the electronic SIM access information may be stored in the service provider information 416. Advertising information, service rate information, support information, contact information, or the like, may also be stored for use by personnel at the customer service portal 120 and/or may be communicated to the user of the wireless media device 106.

In the various embodiments, the electronic SIM access information is sent to the user of the wireless media device 106 for storage on the electronic SIM card 104. In some embodiments, the electronic SIM access information may be generated and stored in the SIM access information 418 portion of the client information database 230. Thus, the electronic SIM access information is readily available, and may even be retrieved and modified as needed, for sending to the user's wireless media device 106.

Other information of interest may be stored in the information of interest 420 portion of the client information database 230. For example, miscellaneous product advertising information may be stored, and then communicated to the user's wireless media device 106 with the communicated electronic SIM access information. Or, the stored information of interest may be separately communicated to the user's wireless media device 106.

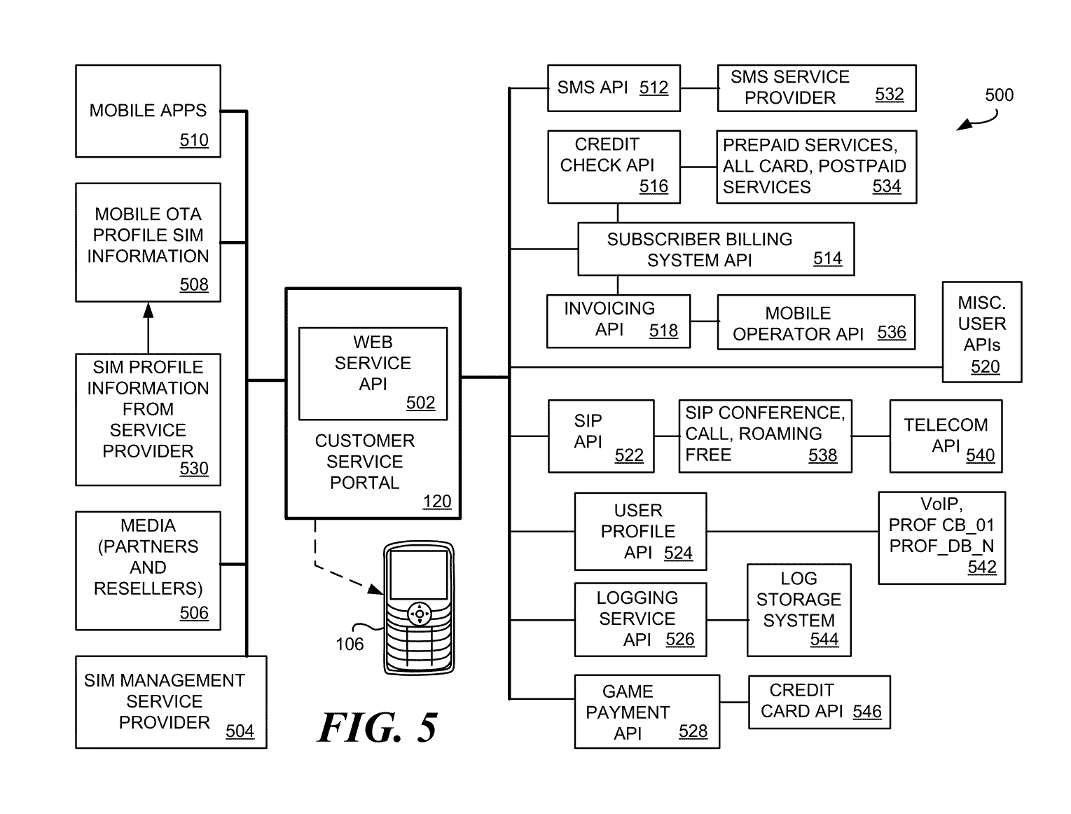

FIG. 5 is a block diagram of an exemplary server farm environment 500 that permits various entities to access the user's wireless media device 106 via the customer service portal 120. One or more servers (not shown) executing various web service application programming interfaces (APIs) 502 may be used to implement the server farm environment 500. A server in the server farm environment 500 may be configured to perform multiple functionalities. In other embodiments, multiple servers may be used to implement the exemplary functionality of the server farm environment 502. In some embodiments, the multiple servers may be distributed, and/or may perform additional and/or alternative functions.

The exemplary server farm environment 500 comprises an E-SIM management service provider function (e.g., component or unit) 504, a media service function 506, a mobile over the air (OTA) profile service function 508, a mobile application (App) function 510, a short message system (SMS) function 512, a subscriber billing application programming interface (API) function 514, a credit check API function 516, an invoicing API function 518, a miscellaneous user API function 520, a session initiated protocol (SIP) API function 522, a user profile API function 524, a logging service API function 526, and/or a service payment API function 528. Other functions (components or units) not expressly described herein may be incorporated into the server farm environment 500. In other embodiments, the server farm environment 500 may include fewer functions.

The E-SIM management service provider function 504 enables the E-SIM management service provider to manage subscriber accounts and control various communications between the customer service portal 120 and the user's one or more wireless media devices 106. For example, the E-SIM management service provider function 504 may verify which particular services the user has subscribed to, may determine what other services may be provided to the subscriber at no cost, and/or may control the communication of supplemental information to the user's one or more wireless media devices 106.

The media service function 506 enables communication of various media to the user's one or more wireless media devices 106. For example, but not limited to, the exemplary media service function 506 may include a “whitelabel” service of music media provided by partners and resellers. Once communications are established with the user's one or more wireless media devices 106, such media content may be communicated from the customer service portal 120 to the wireless media device 106.

The mobile OTA profile service 508 enables SIM profile information to be provided to the E-SIM management service provider and/or to the user's one or more wireless media devices 106 via the customer service portal 120. For example, a service provider may provide SIM profile information 530, and/or other information of interest, to the exemplary server farm environment 500. The information may be used for any suitable purpose, such as customer data and billing information management or the like.

The mobile Apps function 510 enables communication of various applications (Apps) to the user's one or more wireless media devices 106 via the customer service portal 120. For example, but not limited to, applications for a store provider may be provided to the server farm environment 500. Since attributes pertaining to the user's one or more wireless media devices 106 is available at the customer service portal 120, suitable applications may be selected, and/or reconfigured, and then communicated to the user's one or more wireless media devices 106. To illustrate, a mobile game playing application may be configured for a cellular phone. Another mobile game playing application, having the same functionality, may be configured for a portable laptop computer. Based on information at the customer service portal 120 that identifies the type of the user's wireless media device 106, the correctly configured mobile game playing application may be sent to the wireless media device 106 through the customer service portal 120.

The short text message (SMS) system function 512 enables communication of SMS type communications between the user's one or more wireless media devices 106 and various entities and/or end user devices, via the customer service portal 120. For example, a SMS service provider 532 may access the server farm environment 500, and thus gain access to the user's one or more wireless media devices 106 through the customer service portal 120.

The subscriber billing API function 514 provides for various billing functions that may be applied to, and/or used by, the user that has subscribed to the E-SIM management service provider. That is, the user may be billed for a service, and/or may pay for a service, via the customer service portal 120.

For example, but not limited to, the credit check API function 516 enables the E-SIM management service provider, based on information regarding its subscribers stored in the client information database 230, to provide information to and receive information from a credit check entity for credit verification and/or credit checking of a subscriber. The credit verification and/or credit checking information may be used by the E-SIM management service provider. Additionally, or alternatively, the credit verification and/or credit checking information may be used by other entities that have subscribed for the credit verification and/or credit checking service.

In some applications, an entity may provide the prepaid service, all card service, postpaid service functions 534, or the like, to the subscriber of the E-SIM management service provider. For example, the user may be travelling in a foreign country and wish to access and use a cellular network in the foreign country. The user, via an accessible one of the customer service portals 120 operated by the E-SIM management service provider, may prepay, post pay, or make other payment arrangements to access and use the cellular network.

The invoicing API function 518 permits the invoicing for services provided to the user and/or to the user's one or more wireless media devices 106, via the customer service portal 120. For example, a mobile operator API function 536 may be used to bill the user for subscribed services over a particular service provider's system.

The miscellaneous user API function 520 enables the user to access various APIs of interest through the customer service portal 120. For example, a calendar, a news report, a reservation booking system, a partner system, a chat service, an object locator service, or the like, may be accessed by, and then used by, the user's one or more wireless media devices 106.

The session initiation protocol (SIP) API function 522 supports multimedia communications of the user's one or more wireless media devices 106. For example, various multimedia communication services 538 (VoIP, SIP conference, call roaming, free service, etc.) may be provided by accessing a telecommunication (telecom) API 540.

The user profile API function 524 supports user profiling functions, such as usage history and/or consumer activities. The user profile information may be provided to, or received from a suitable source, such as, but not limited to, PROF CB_{—}01 or PROF_DB_N 542, through the customer service portal 120.

The logging service API function 526 enables the user's one or more wireless media devices 106 to report various events back through the customer service portal 120 for incorporation into a service log or the like. The event information may be stored in a log storage system 544.

The service payment API 528 enables the user to pay for various entertainment services, such as guild wars (GW). For example, if a GW payment is to be made so that the user may play the game, the service payment API 528 may access a credit card API 546 to make the necessary payments. Product service payments may similarly be made through the customer service portal 120.

In some embodiments, one or more of the API functions may be provided by third party systems in an integrated or distributed fashion.

In some exemplary embodiments, the user's wireless media device 106 may be remotely locked so that other cellular systems cannot be accessed and used by the wireless media device 106. That is, once new electronic SIM access information has been received and stored in the electronic SIM card 104, the electronic SIM card 104 can be locked such that the electronic SIM access information cannot be later updated, replaced, and/or revised without an unlock key, an unlock authorization, or the like. The unlocking may be provided by using an OTA signal originating from the customer service portal 120, or via another suitable link such as, but not limited to, an IP link.

For example, the lock may be required as a condition of an agreement for a price reduction or subsidy entered into with a new cellular system operator. The E-SIM management service provider and/or the new cellular system operator may include the lock with newly transmitted electronic SIM access information that authorizes access to and use of the cellular network operated by the new cellular system operator. The “lock” prevents the user from later changing the stored electronic SIM access information so as to enable access to a different cellular network.

In some situations, the lock placed on the electronic SIM card 104 may be circumvented, broken, and/or overridden by the SIM management service provider. For example, there may be a dispute or the like between the user and the new cellular system operator. As another example, the user may wish to access a service that falls outside of the service agreement between the user and the new cellular system operator. Thus, the SIM management service provider may unlock the electronic SIM card 104 so that updated electronic SIM access information may be downloaded into the electronic SIM card 104 so that the wireless media device 106 may access and use another cellular system.

Furthermore, in some embodiments, some or all of the components of the electronic SIM system 100 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. In addition, some or all of the system components and/or data structures may be implement by a general purpose or a special purpose computing system suitable instructed to perform the functions described herein. Some or all of the system components and/or data structures described herein, or implicitly included in the various embodiment, may also be stored (e.g., as executable or other machine readable software instructions or structured data) on a computer-readable medium (e.g., a hard disk; a memory; a network; or a portable media article to be read by an appropriate drive or via an appropriate connection). Some or all of the system components and data structures may also be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with any suitable computer system configuration.

It should be emphasized that the above-described embodiments of the electronic SIM system 100, and the associated optional server farm environment 500, are merely possible examples of implementations of the invention. Many variations and modifications may be made to the above-described embodiments. All such modifications and variations are intended to be included herein within the scope of this disclosure and protected by the following claims.

All of the above U.S. patents, U.S. patent application publications, U.S. patent applications, foreign patents, foreign patent applications and non-patent publications referred to in this specification and/or listed in the Application Data Sheet, including but not limited to U.S. application Ser. No. 13/304,183, entitled “APPARATUS, SYSTEMS AND METHODS FOR PROGRAMMABLE SIM CARD USING OVER THE AIR COMMUNICATED INFORMATION,” filed Nov. 23, 2011; and U.S. Provisional Patent Application No. 61/416,945, entitled “APPARATUS, SYSTEMS AND METHODS FOR PROGRAMMABLE SIM CARD USING OVER THE AIR COMMUNICATED INFORMATION,” filed Nov. 24, 2010, are incorporated herein by reference, in their entireties.

1. A method for accessing a wireless cellular network, comprising:
receiving at a wireless media device electronic subscriber identity module (SIM) access information pertaining to a selected wireless cellular network; and
configuring the wireless media device to communicate over the selected wireless cellular network based on the received electronic SIM access information.

2. The method of claim 1 wherein the received electronic SIM access information is received in an over the air signal.

3. A wireless media device comprising:
an electronic SIM card configured to:
receive access information regarding a first selected wireless cellular network belonging to a first communications provider;
configure the wireless media device to communicate over the first selected wireless cellular network;
receive access information regarding a second selected wireless cellular network belonging to a second communications provider; and
automatically configure the wireless media device to communicate over the second selected wireless cellular network.

4. The device of claim 3 wherein the first and/or second selected wireless cellular network is user selected.

5. The device of claim 3 wherein access to the first selected wireless cellular network ends when access to the second selected wireless cellular network begins.

6. A computer-readable medium storing instructions for executing the method of claim 1.
